(19) United States
(12) Patent Application Publication
(10) Pub. No.: US 2018/0114254 A1
(43) Pub. Date: Apr. 26, 2018

(54) Interactive Data-Driven Graphical User Interfaces for Investigating Display Advertising Performance

(71) Applicant: Rise Interactive Media & Analytics, LLC, Chicago, IL (US)

(72) Inventors: Brent Laufenberg, Chicago, IL (US); Andrea McLeod, Chicago, IL (US); David Locke, Chicago, IL (US); Michael Thone, Chicago, IL (US); Lawrence Fisher, Chicago, IL (US); Jonathon Morris, Chicago, IL (US)

(21) Appl. No.: 15/334,516

(22) Filed: Oct. 26, 2016

(51) Int. Cl. G06Q 30/02; G06F 3/0482

(52) U.S. Cl. CPC G06Q 30/0277; G06F 3/0482; G06Q 30/0243

(57) ABSTRACT

An embodiment may involve repeatedly receiving, from one or more online advertising service devices at which one or more web-based display advertising campaigns are operated, updates to information related to display advertisement placement and display advertisement performance associated with the one or more web-based display advertising campaigns. The information may include a plurality of metrics. The embodiment may further involve receiving, via selectable controls on a graphical user interface of a client device, a selection of two of the plurality of metrics. The embodiment may also involve transmitting, for display on the graphical user interface, data representing values of the selected two metrics over a pre-defined period of time. Reception of the data may causes the client device to plot a graph indicating the values of the selected two metrics over the pre-defined period of time, where the values as shown in the graph for each of the selected two metrics are normalized to one another.

### BACKGROUND

Online advertising uses the Internet or other data networks to provide promotional and marketing messages to consumers and/or potential customers. It includes web-based advertising, email advertising, search engine advertising, social media advertising, and mobile advertising. The parties involved include an advertiser, who provides advertisement (ad) copy, a publisher, who integrates the ads into its online content, and a user, who is presented with the online ads. An online advertising service may match advertisers with publishers, and may select the specific ads that are viewed by particular users that access the publisher's content. Another potential participant is an advertising agency, who may help generate and place the ad copy.

Unlike traditional print, radio, and television advertising, online advertising allows hyper-focused targeting of ads to particular users, groups of users, and other channels. Nevertheless, regardless of targeting, it currently lacks the tools for advertisers and advertising agencies to be able to manage advertising budgets on a granular scale or to determine, in near-real-time, the efficacy of the advertisements placed.

### SUMMARY

The embodiments herein involve, but are not limited to, ways in which online advertising performance information can be displayed on a graphical user interface so that an advertiser can rapidly determine the effectiveness of one or more web-based display advertising campaigns. In particular, the computer implementations described hereafter may automatically retrieve online advertising placement and conversion information from one or more remote networked sources, and provide a graphical user interface that presents this information in a logical and readable fashion. The advertiser can filter and/or modify the display to focus on information that is relevant to the advertiser's goals.

For instance, the graphical user interface might plot the cost of advertising and conversions for a particular advertising campaign over a time period (e.g., the last month). By way of this display, the advertiser can rapidly determine whether the advertising campaign is performing to expectations. For instance, anomalies or discrepancies may be readily apparent in the display, prompting the advertiser to explore these areas further. The graphical user interfaces may also allow the advertiser to “drill down” into specific data to facilitate this exploration so that the advertiser can intelligently and rapidly allocate funds. Thus, the embodiments herein solve technical problems associated with the displaying of relevant display advertising performance information on a graphical user interface.

A first example embodiment may involve repeatedly receiving, from one or more online advertising service devices at which one or more web-based display advertising campaigns are operated, updates to information related to display advertisement placement and display advertisement performance associated with the one or more web-based display advertising campaigns. The information may include a plurality of metrics. The first example embodiment may further involve receiving, via selectable controls on a graphical user interface of a client device, a selection of two of the plurality of metrics. The first example embodiment may also involve transmitting, for display on the graphical user interface, data representing values of the selected two metrics over a pre-defined period of time. Reception of the data may cause the client device to plot a graph indicating the values of the selected two metrics over the pre-defined period of time, where the values as shown in the graph for each of the selected two metrics are normalized to one another.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 depicts an online advertising diagram, according to an example embodiment.

FIG. 5A depicts an advertising agency offering graphical user interfaces that provide information on display advertising performance, according to an example embodiment.

FIG. 5B depicts relationships between keywords, advertisements, and landing web pages, according to an example embodiment.

FIG. 6 depicts an architecture for display advertising performance tracking, according to an example embodiment.

FIG. 7 depicts display advertising, according to an example embodiment.

FIG. 8A depicts controls for graphical user interfaces, according to an example embodiment.

FIG. 8B depicts controls for graphical user interfaces, according to an example embodiment.

FIG. 8C depicts controls for graphical user interfaces, according to an example embodiment.

FIG. 8D depicts controls for graphical user interfaces, according to an example embodiment.

FIG. 8E depicts controls for graphical user interfaces, according to an example embodiment.

FIG. 8F depicts controls for graphical user interfaces, according to an example embodiment.

FIG. 8G depicts controls for graphical user interfaces, according to an example embodiment.

FIG. 8H depicts controls for graphical user interfaces, according to an example embodiment.

FIG. 8I depicts controls for graphical user interfaces, according to an example embodiment.

FIG. 8J depicts controls for graphical user interfaces, according to an example embodiment.

FIG. 8K depicts controls for graphical user interfaces, according to an example embodiment.

FIG. 9 depicts a flowchart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### 1. OVERVIEW

As noted above, online advertising services may facilitate the offering of specific ads from advertisers to particular users. In some embodiments, an online advertising service may partner with publishers (e.g., web sites, search engines, social networks, mobile applications, etc.) that deliver content to users. The advertiser may submit ads for the online advertising service to place, and the online advertising service may select specific ads to display for each affiliated publisher. The ads may be selected dynamically so that they are likely to be related to the content being viewed, or of interest to users that typically view the content. Alternatively or additionally, when demographic or personal information about a particular user is known, the ads may be targeted to that particular user. In some cases, the online advertising service may be a publisher itself; for instance, a search engine operator may allow advertisers to place ads that are integrated with its search results.

Payment models for online advertising vary. In some models, known as cost-per-mille (CPM), advertisers pay a specific amount for every 1000 ads provided for viewing by users (sometimes called “impressions” though a user might not actually view the ad if he or she closes the application that is to display the ad, for instance). On the other hand, in pay-per-click (PPC) models, the advertiser pays when users click on or select a displayed ad, indicating further interest in the product or service being advertised. Newer models include pay-per-performance (PPP) or pay-per-engagement (PPE) advertising, in which the advertiser pays when the user undertakes a particular set of one or more actions. These actions may result in leads for the advertiser, such as users filling out an online form, accessing a particular uniform resource locator (URL), downloading a particular file, watching a particular video, or dialing a particular phone number. These actions may also include conducting an online purchase of a particular product or service.

Regardless of the payment model, the advertiser's payment may be divided, in some fashion, between the content provider serving the ads and the online advertising service. For instance, the content provider may obtain 70% of each unit of payment, while the online advertising service obtains the remaining 30%.

Some online advertising services operate under an auction model. Advertisers may select, for instance, keywords or keyphrases with which they would like their ads associated, as well as a bid amount. The online advertising service then, in turn, displays the ad of a selected bidder (e.g., the highest bidder) on web pages or other media that also display (or are otherwise associated with) the selected bidder's keywords or keyphrases. For example, ads bundled with the keywords “auto,” “automobile,” and “car” may be displayed on web sites or other media that contain content related to cars and/or driving. In some cases, the online advertising service may display the ad to a user contextually associated with the selected keywords or keyphrases. The user may have, in the past, expressed interest in these keywords or keyphrases, or is deemed likely to have such an interest. Thus, in the case of the above example, if the user is deemed interested in cars, the ads may be displayed to a user in web sites or other media that are not related to cars and/or driving.

The terms “keywords” and “keyphrases” may refer to single words and groups of words, respectively. For sake of convenience, these terms may be used interchangeably herein.

Measuring the effectiveness of online advertising campaigns can be challenging given the variety of online advertising services and payment models. An advertiser may wish to distribute its advertising budget across more than one online advertising service, and/or may wish to use multiple payment models. The effectiveness may be measured in terms of conversions—the number of users who engaged with the ads of the campaign. But several types of conversions exist: impressions, click-throughs, leads, downloads, phone calls, purchases, as well as any other type of activity that the advertiser has defined as valuable. Some of these conversion types may involve assisted conversions. Additional categories of conversions may exist.

For instance, assisted conversions include interactions that a user has with publishers leading up to a conversion. For example, if conversions are measured in terms of purchases, the user may visit a particular publisher several times before conducting the actual purchase. These visits may be information gathering exercises for the user. Nonetheless, the non-purchase visits may be tracked as “assists” and the eventual purchase may be categorized as an assisted conversion.

Online advertising services may be able to track the number of impressions and click-throughs for each ad. However, these services might not have the information to determine that a user who viewed an ad later expressed further interest in, or purchased, a related product. Thus, conversion information regarding the effectiveness of online advertising is currently available only in limited situations.

The embodiments herein support methods, devices, and systems for providing a more complete view of an advertiser's conversions. These embodiments collect and aggregate information from one or more online advertising services, as well as traffic tracking services, to enable near-real-time monitoring of advertising spending and advertising conversions. With this information, advertisers and/or their advertising agencies may be able to make faster, more informed decisions about how to allocate their advertising budgets to ad copy, online advertising services, and/or publishers. For instance, in the past, detailed information regarding conversions was largely unavailable. When this information was available, processing it into a format that could be analyzed would take days. At that point, any recent anomalies had occurred too far in the past to address. With the embodiments herein, anomalies can be identified in minutes and addressed in real time.

Particularly, the embodiments herein describe interactive data-driven graphical user interfaces, possibly in the form of web pages, that allow an advertiser to rapidly compare various types of data related to the performance of online advertisement. For instance, an advertiser and/or their advertising agency may be able to compare, at a glance, the amount spent on online advertising over a particular defined time period to conversions as a result of the advertising for that time period. Similarly, with inputs to the graphical user interfaces, these parties may be able to switch to comparing the number of ad impressions over the particular defined time period to the cost of advertising for that time period. The graphical user interfaces may visually identify how well the advertising spending or advertising impressions correlate to conversions.

In this way, the parties may be able to rapidly determine the effectiveness of each of their advertising campaigns, and whether they should change strategies for any of these campaigns. For instance, the parties may decide to discontinue a campaign with a low conversion rate, and re-allocate that budget to a campaign with a higher conversion rate. On the other hand, the parties may decide to increase the advertising budgets for important campaigns with lower than expected conversion rates. In some cases, the display on the graphical user interfaces may identify a discrepancy between two metrics that are expected to be highly correlated (e.g., advertising spending and conversions). Once presented with such a discrepancy, the advertiser may interact with the graphical user interface to determine a possible cause of the discrepancy.

While the embodiments herein are described as providing web-based interfaces, other types of interfaces may be used instead. For instance, any of the web-based interfaces herein may be replaced by interfaces of standalone applications for personal computers, tablets, smartphones, etc. Further, even though online advertising agencies are described throughout this disclosure as placing ads on behalf of advertisers, these agencies are not necessary. Thus, the embodiments herein may be used by advertisers themselves without assistance from an online advertising agency.

Regardless of how they may be implemented, the embodiments herein may make use of one or more computing devices. These computing devices may include, for example, client devices under the control of users, and server devices that directly or indirectly interact with the client devices. Such devices are described in the following section.

### 2. EXAMPLE COMPUTING DEVICES AND CLOUD-BASED COMPUTING ENVIRONMENTS

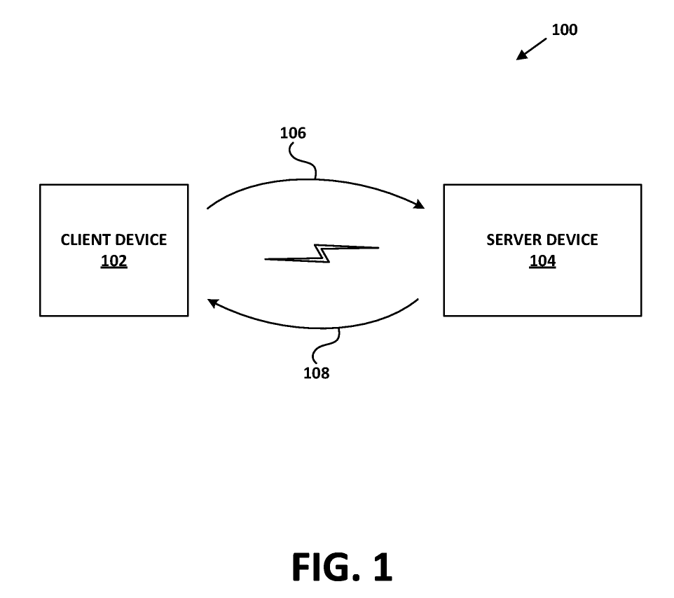

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

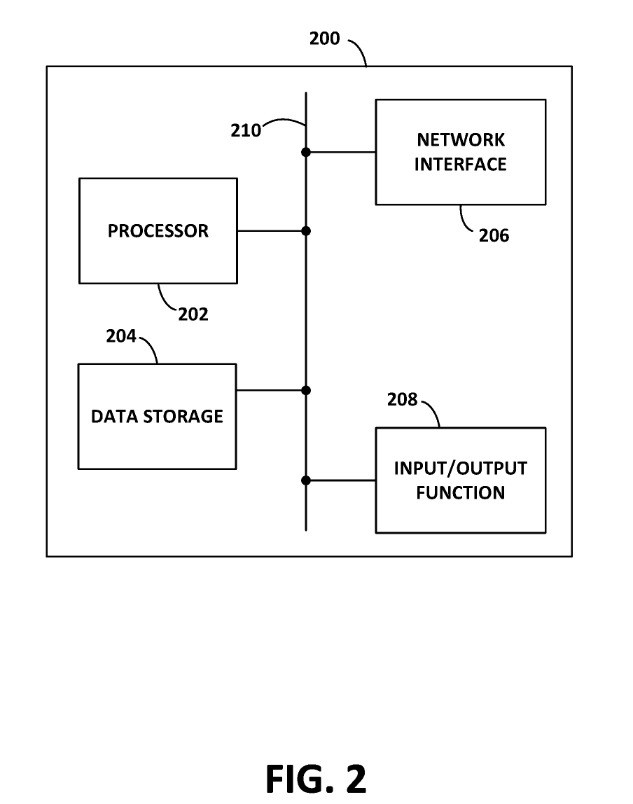

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purpose of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more central processing units (CPUs), such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile memory and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

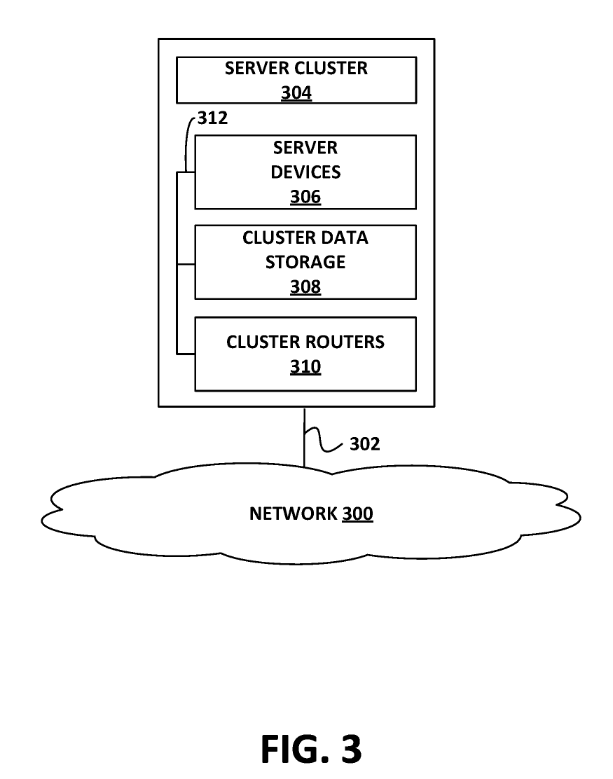

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purpose of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### 3. EXAMPLE ONLINE ADVERTISING ARCHITECTURES AND CONVERSION TRACKING

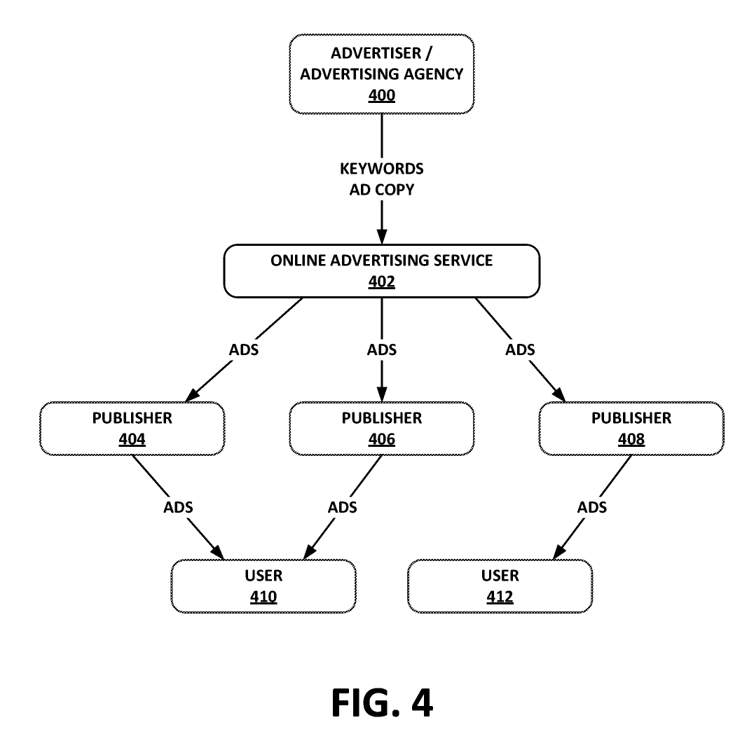

FIG. 4 depicts an online advertising diagram, according to an example embodiment. In FIG. 4, advertiser/advertising agency 400 may provide keywords, ad placement information, and/or ad copy to online advertising service 402. The advertiser and the advertising agency may, for example, work together to select the keywords, select target placements, and develop the ad copy. On the other hand, either of these parties may operate independently from the other when selecting the keywords, selecting the target placements and developing the ad copy. In some embodiments, the advertiser hires the advertising agency to manage the advertiser's online advertising. The advertising agency may also assist the advertiser with other aspects of marketing strategies, branding strategies and/or sales promotions.

Regardless of the exact relationship between the advertiser and the advertising agency, the online advertising may be associated with one or more spending goals and/or conversion goals defined by either party. These goals may take various forms. In some possible examples, the spending goals may include a monthly advertising budget, perhaps with day-by-day spending sub-goals, and the conversion goals may include a target number of monthly conversions, perhaps with day-by-day conversion sub-goals. The conversion goals may also specify how these conversions can be counted. Other possibilities exist.

Online advertising service 402 may be an entity that receives keywords and associated ad copy from one or more advertisers and/or advertising agencies, and provides the ad copy to publishers for display to users. As shown in FIG. 4, online advertising service 402 may provide one or more ads to publishers 404 and 406 that are viewed by user 410, and one or more ads to publisher 408 that are viewed by user 412. Examples of online advertising services include Google's ADWORDS®, Microsoft's BING® Ads, Automattic's WORDADS®, and so on.

Publishers 404, 406, and 408 may be entities that operate and/or provide web sites, social networks, personal computer applications, mobile applications, search engines, and so on. Each of these types of publishers may provide content potentially of interest to users. Along with this content, publishers 404, 406, and 408 may also provide various types of ads to the users, such as text-based ads, banner ads, column ads, video ads, overlay ads, interstitial ads, etc.

Users 410 and 412 may be individuals accessing the content at publishers 404, 406, and 408. Before, during, and/or after viewing this content, users may view ads. In some cases, users 410 and 412 may be required to view a certain extent of an ad, or view the ad for a certain period of time, before the content is displayed.

Other arrangements with more advertisers, advertising agencies, online advertising services, publishers, and users are possible. In some cases, the number of advertisers, publishers, and/or users may be in the thousands or millions.

As noted above, the ads provided to a particular publisher may be selected to be related to that publisher's content. For instance, if publisher 408 is a web site providing information on automobiles, online advertising service 402 may provide ad copy associated with the keyword “car” to publisher 408. Alternatively or additionally, when the online advertising service has access to information regarding a particular user that is viewing a publisher's content, the online advertising service may provide ads related to known interests of the particular user. Thus, for instance, if user 410 is known to be interested in automobiles, the online advertising service may provide ad copy associated with the keyword “car” to publishers 404 and/or 406 for display to user 410, even if the content that these publishers provide is not related to automobiles.

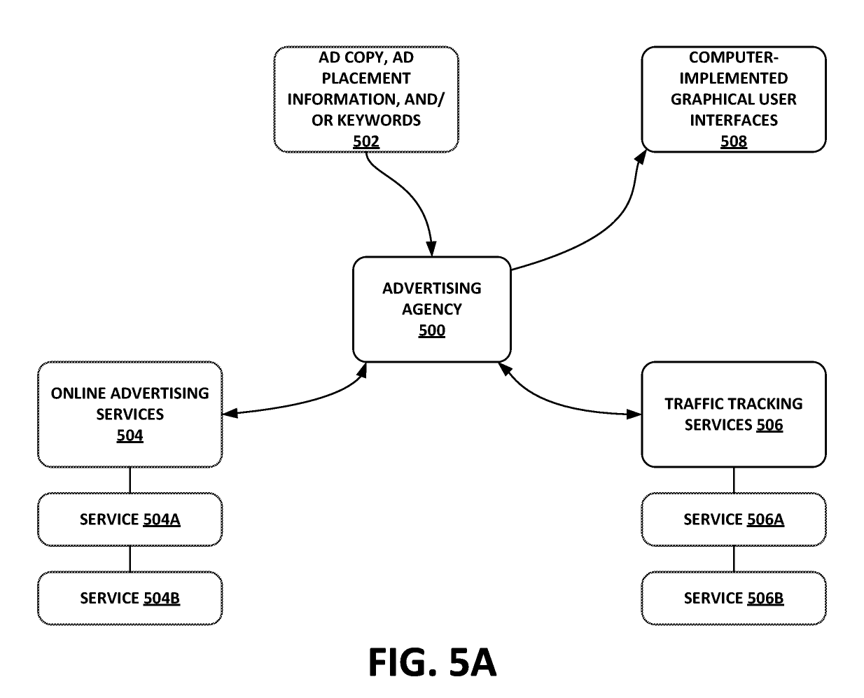

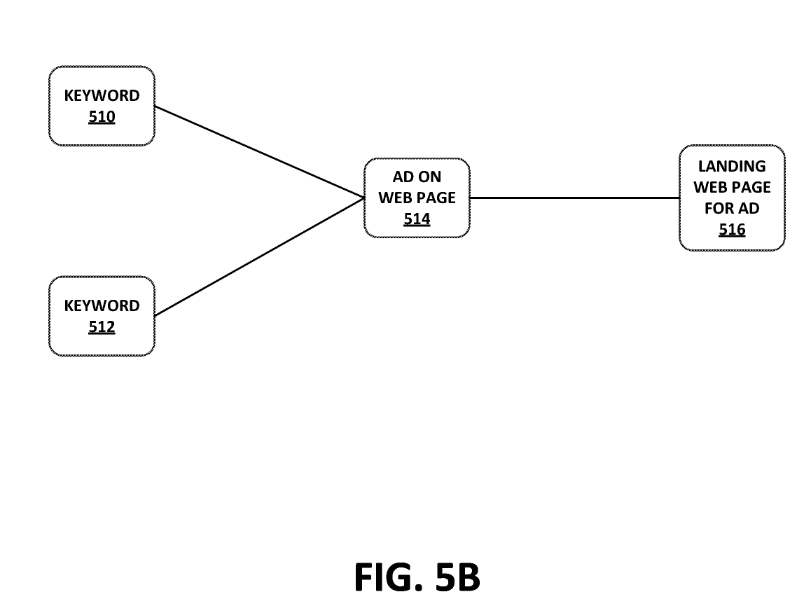

FIG. 5A depicts an advertising agency 500 offering graphical user interfaces that provide information regarding display advertising performance, according to an example embodiment. Advertising agency 500 may place ads with one or more online advertising services 504 on behalf of one or more advertisers.

Each advertiser may provide ad copy, ad placement information, and/or keywords 502 to advertising agency 500. Ad copy may include text, graphics, audio, and/or video that make up an online ad. Keywords may include one or more words or phrases that the advertiser seeks to associate with the ad copy. In some cases, the ad copy, ad placement information, and/or keywords may be developed by the advertiser, both the advertiser and advertising agency 500, or by advertising agency 500 with little or no input from the advertiser.

Given ad copy, ad placement information, and/or keywords 502, advertising agency 500 may place ads with one or more of online advertising services 504. As just one example, service 504A may be Google's ADWORDS®, while service 504B may be Microsoft's BING® Ads. Thus, advertising agency 500 may provide the ad copy and associated keywords to one or more of online advertising services 504. In some cases, the same ad copy and keywords may be used for each service, and in other cases, ad copy and keywords may differ between at least some of these services. Once the ad copy and keywords are provided, online advertising services 504 may begin providing ads for their respective publishers to display to users.

As noted above, some online advertising services 504 may use a form of auction to determine the price that the advertiser is charged to place its ads. More specifically, the advertiser may bid to have an ad associated with one or more keywords. An online advertising service then, in turn, displays the ad of a selected bidder on web pages or other media that also display (or are otherwise associated with) the selected bidder's keywords. In some cases, the selected bidder may be the one that bid the highest amount. In general, however, other factors may be taken into consideration.

The relationships between keywords, ads, and web pages are illustrated in FIG. 5B. Therein, keywords 510 and 512 are associated with ad 514. This association may be made by an advertiser who would like users interested in keywords 510 or 512 to view ad 514. For example, ads associated with the keywords “automobile,” and “car” may be displayed on a web site deemed to be relevant to these keywords.

If a user to which ad 514 is displayed clicks on, touches, or otherwise activates this ad, the user may be redirected to landing web page 516 (e.g., a click-through has occurred). In most cases, landing web page 516 contains information relevant to keywords 510 and 512. As an example, landing web page 516 may contain information about automobiles and cars. For instance, landing web page 516 may be the main web page of a car dealership, or a web page of the car dealership that displays information about a current sale taking place.

Clearly, advertisers would like to have their ads associated with certain keywords. But they are usually competing with other advertisers for this privilege, and the online advertising service ultimately decides which ads are associated with which keywords and for how long. In some cases, the online advertising service may allow multiple ads from the same or different advertisers to be simultaneously associated with the same keywords. For example, a web site might simultaneously display two or more ads from different advertisers.

In order to determine the associations between keywords and the placement of particular ads, the online advertising service may require that advertisers bid for keywords. In some cases, the highest bidder wins. In other cases, additional information may be taken into account. For instance, the online advertising service may try to improve the user experience with online ads by selecting ads to associate with a keyword based on a quality score.

In online advertising, a quality score may be a numeric or symbolic representation of the quality and relevance of a keyword based on its associated online ads and their respective landing web pages as determined by an online advertising service. Factors that impact a quality score include, but are not limited to: (i) an ad's past click-through rate, (ii) how relevant the ad's text is to the keyword, (iii) the landing web page's relevance to the keyword, ease of navigation, and loading times, (iv) geographic relevance, and/or (v) how well the ad has performed when viewed on different types of client devices, such as personal computers, tablets, smartphones, etc. Other factors may be used as well as or instead of any of these factors.

In some embodiments, a quality score may be represented as an integer, taking on values from 1 to 10. On this scale, 1 is the lowest possible quality score and 10 is the highest. An online advertising service may determine which ads are displayed, or the order in which ads are displayed, based on a formula that includes the quality score of the ad and its landing web page with respect to the keyword, and the advertiser's bid amount for that keyword. Thus it is advantageous for an advertiser to match ads with appropriate keywords, as well as to design a relevant landing web page that performs well across various types of client devices. Based on these criteria, an advertiser that bids less for a keyword, but has a more relevant ad and a more relevant, better-performing web site may be preferred over an advertiser that bids more for the keyword but has a less relevant ad or a less relevant, poorer-performing web site.

Turning back to FIG. 5A, a demand side platform (DSP) may exist between advertising agency 500 and online advertising services 504. The DSP may be web-based or client-based software that enables various entities to buy display impressions across multiple online advertising services in an automated or semi-automated fashion. The DSP may perform analytics to establish the value of an impression, and then place a bid accordingly. DSPs may be operated by third parties other than advertising agency 500 or online advertising services 504. Examples of DSPs include those of MediaMath® and Invite Media.

Regardless of how ads are placed, each set of ad copy and associated keywords may be part of a distinct advertising campaign. Some advertising campaigns may include multiple sets of ad copy and associated keywords. In some cases, the same ad copy and/or associated keywords can be used across multiple campaigns and/or multiple advertising accounts. For example, an advertiser may have three main brands, each with its own advertising campaign defined by respective sets of ad copy and associated keywords. However, the advertiser may also advertise its company name, with different ad copy and associated keywords, across all of these brands.

As one or more advertising campaigns are launched and supported in this fashion, advertising agency 500 may determine conversions from online advertising services 504 themselves, as well as traffic tracking services 506. Online advertising services 504 may be able to report the number of impressions and click-throughs for a particular ad or advertising campaign, but might not be able to report leads or revenue for the campaign. Thus, advertising agency 500 may use traffic tracking services 506 for these purposes.

Traffic tracking services 506 may include various types of analytics services that track and record user traffic. These may include web based analytics (e.g., with or without HTML tracking tags), application (or app) based analytics, phone call based analytics, and so on. Examples of traffic tracking services include Google Analytics, Adobe Analytics, and Invoca® call tracking.

As an example of web based analytics, a traffic tracking service (e.g., service 506A and/or 506B) may allow an advertiser to insert a unique tracking code into one or more of the web pages on the advertiser's web site. This tracking code may be a snippet of JavaScript or some other programming language. The tracking code may be silently executed by the user's web browser when the user browses the page(s). The tracking code may collect information about the user (e.g., Internet Protocol (IP) address, and/or information about the user's web browser or computing device) and send this information to a traffic tracking service device. Additionally, the tracking code may set one or more browser cookies in the user's web browser. These cookies may store information such as whether the visitor has been to the site before, the timestamp of the current visit, and the referrer site or advertising campaign that directed the visitor to the page (e.g., search engine, ad copy, keywords, etc.).

As an example of phone based analytics, an advertiser's various advertising campaigns, keywords, web pages, and so on may each be associated with a telephone number. More than one telephone number may be used so that specific advertising campaigns, keywords, web pages can be identified.

For instance, an advertiser may be running two different advertising campaigns, each with a different telephone number (e.g., “vanity” numbers used only for this purpose). In the ad copy for these campaigns, one of these phone numbers may appear. For instance, the ad copy may suggest that a user call the displayed phone number if they are interested in the product or service being advertised. Each phone number may be a specially assigned number that is only used for receiving calls related to the respective ad. Thus, each incoming phone call to a particular tracked phone number can be counted as a conversion. As an example, a traffic tracking service may provide software on a computer that receives the incoming call, identifies the associated campaign, and records this information, perhaps with the caller's phone number. Then, the software may route the call to an agent who answers the call.

Advertising agency 500 may continuously or repeatedly retrieve, from online advertising services 504 and traffic tracking services 506, information regarding the amount spent on advertising as well as the conversions for each advertising campaign. This information may be presented in various ways on computer-implemented graphical user interfaces 508, some of which are described below. Since the amount spent and the conversions per advertising campaign can change minute to minute (or even more frequently), the advertising agency may continuously, periodically, or from time to time, retrieve updated representations of these values. In some cases, the retrieval may take place every 1, 2, 5, 10, 15, 20, 30 or 60 minutes, once per every one or more hours, or randomly. With this updated information, computer-implemented graphical user interfaces 508 may be revised accordingly to reflect the information.

Continuous retrieval of this information may involve a computing device affiliated with advertising agency 500 retrieving the information from online advertising services 504 and traffic tracking services 506 at a particular time. When that retrieval completes, the computing device may initiate another such retrieval. Alternatively, the computing device may wait a period of time (e.g., a few seconds or minutes) before initiating a subsequent retrieval.

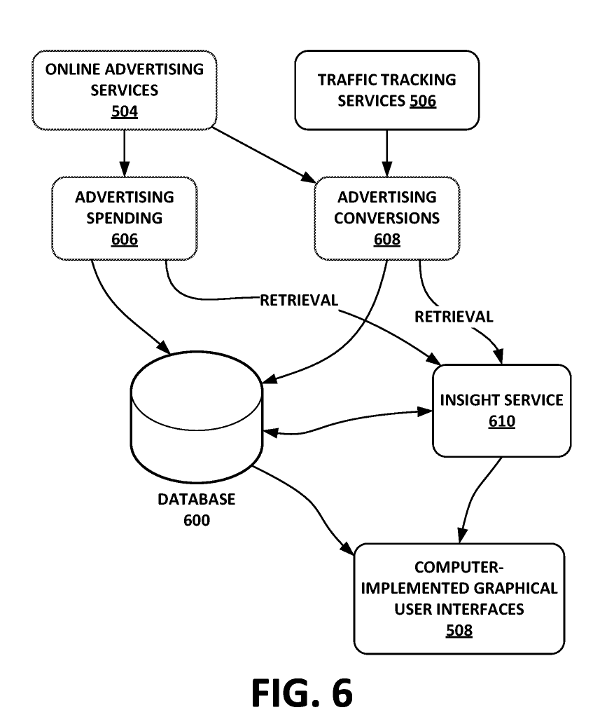

FIG. 6 depicts an architecture for display advertising performance tracking, according to an example embodiment. FIG. 6 provides another view of the embodiments discussed in the context of FIGS. 4, 5A, and 5B.

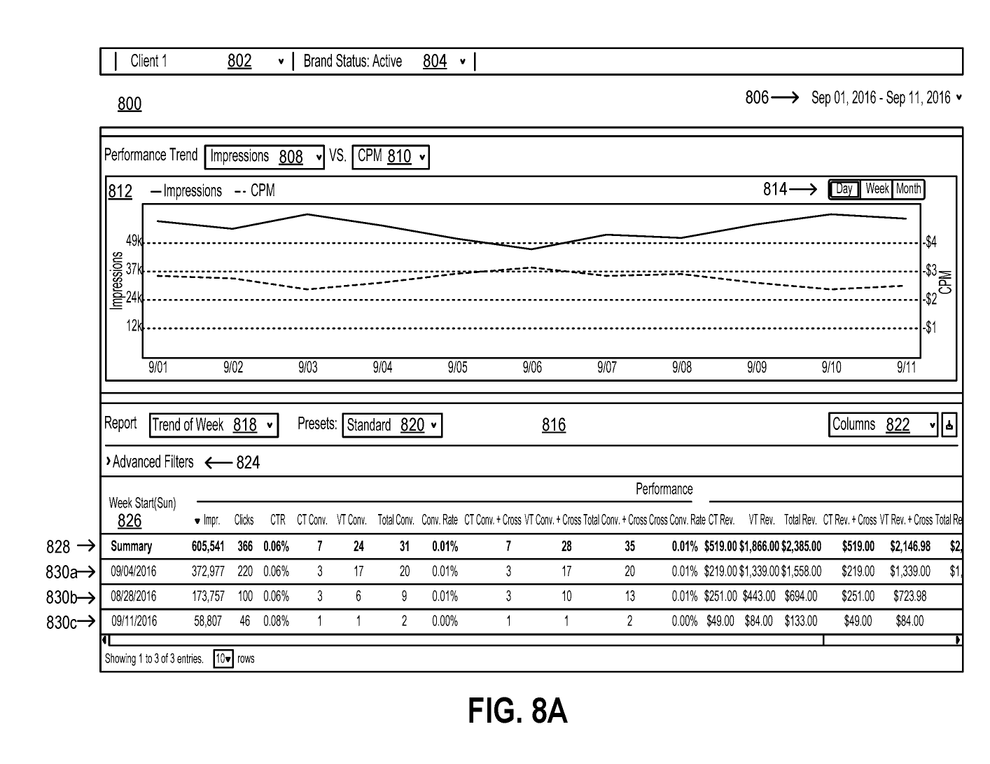

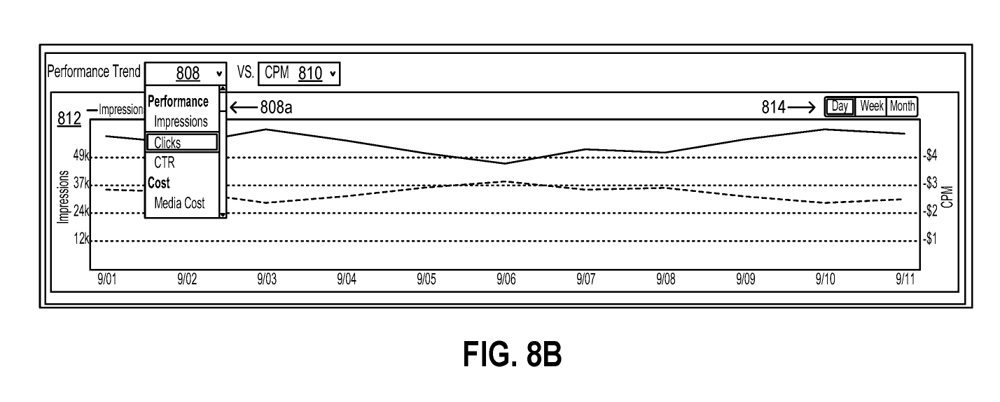

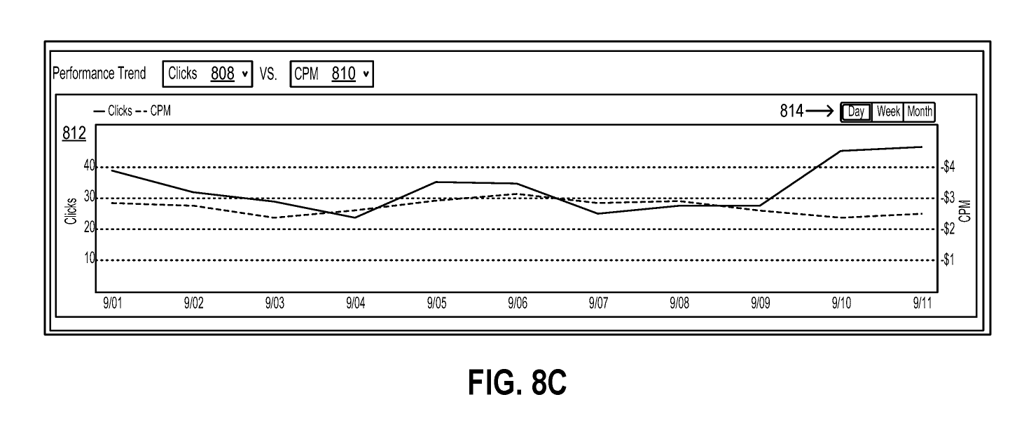

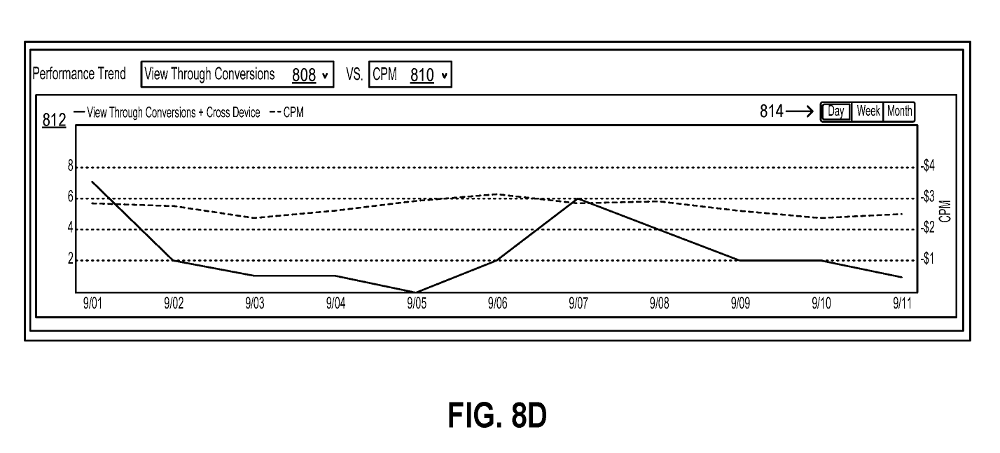

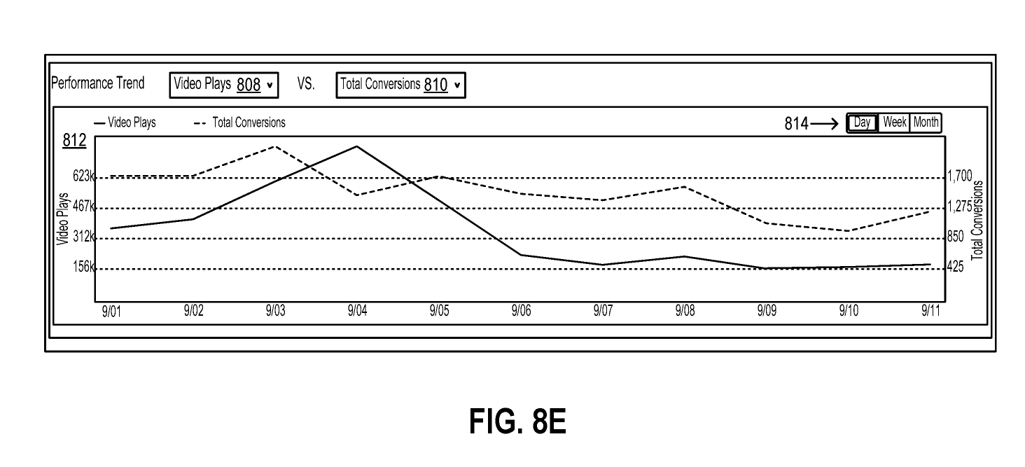

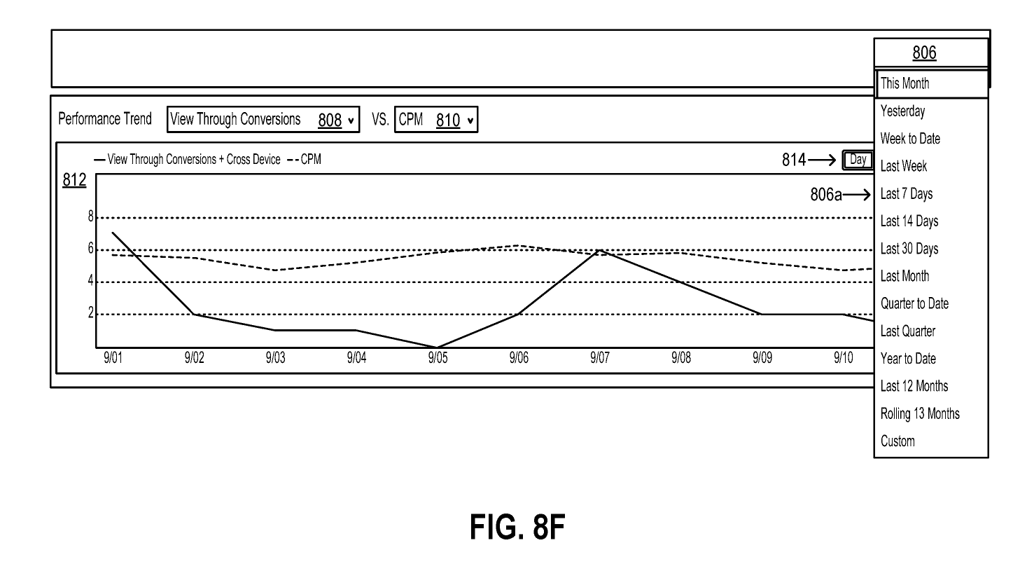

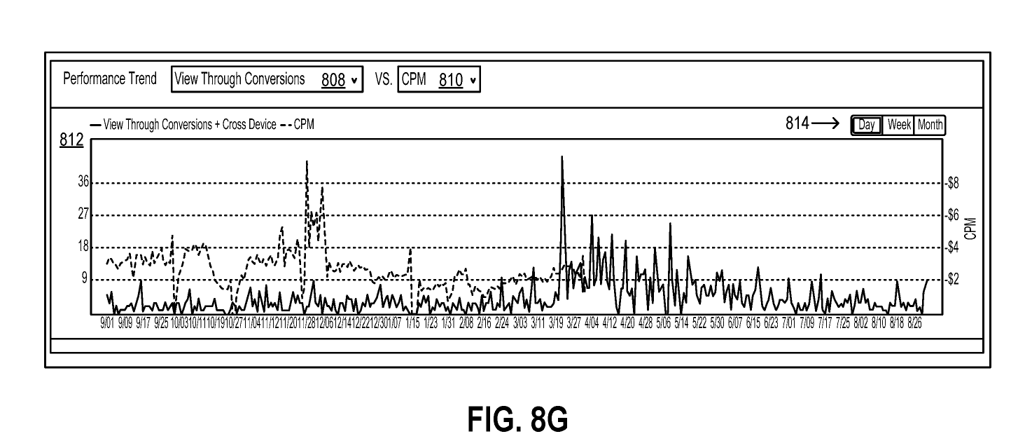

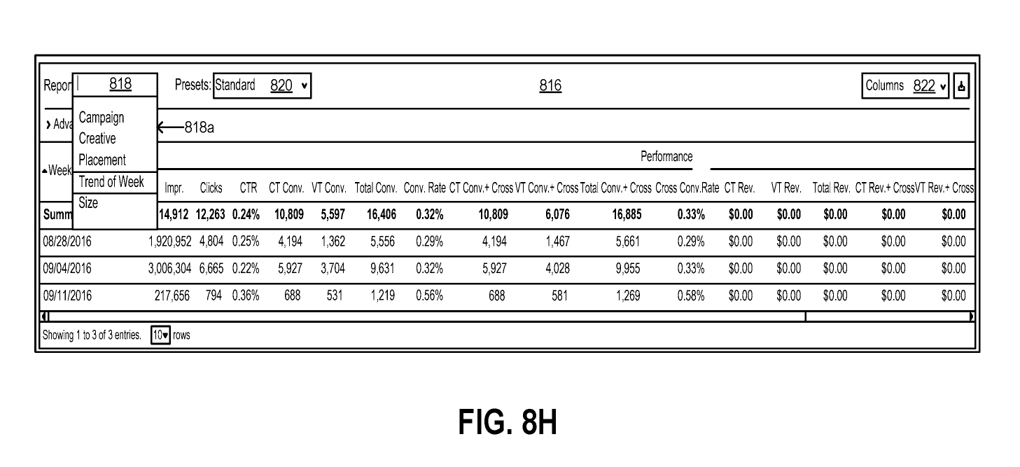

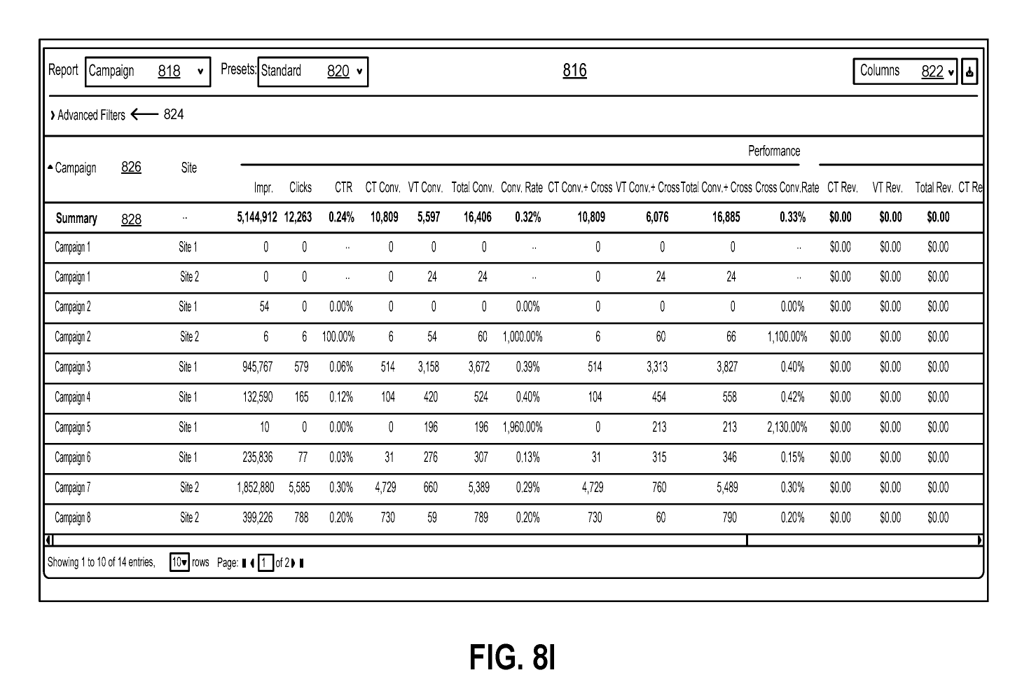

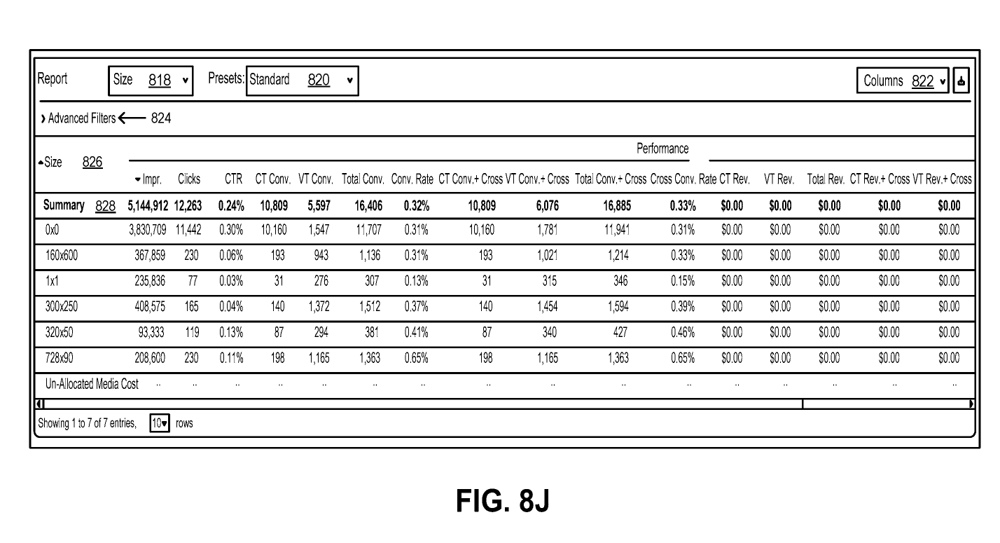

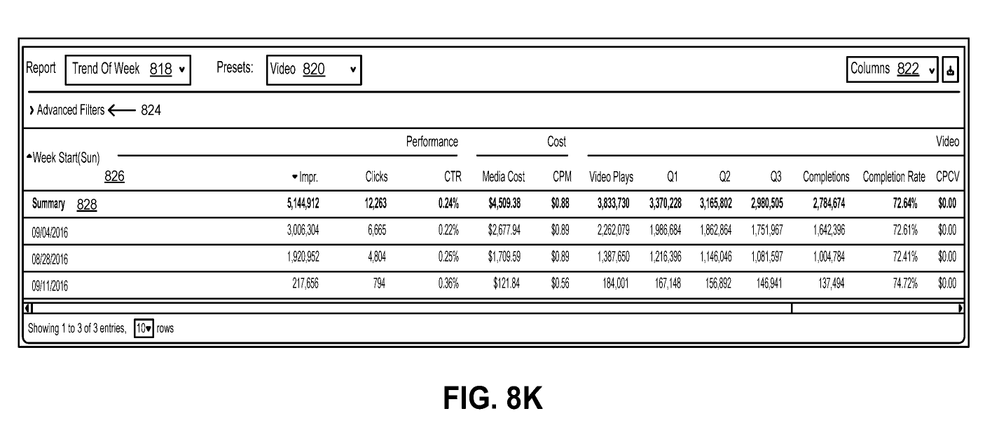

In FIG. 6, online advertising services 504 and traffic tracking services 506 provide advertising spending 606 and advertising conversions 608, each of which may be accessible via respective computing devices. Insights service 610 may be software that operates on another computing device, and may retrieve advertising spending 606 and advertising conversions 608. Insights service 610 may transmit representations of advertising spending 606 and advertising conversions 608 to database 600. Database 600 may store these representations, as well as previously-received representations of advertising spending 606 and advertising conversions 608. Based on one or more of advertising spending 606 and advertising conversions 608, and/or other data as well, database 600 and/or insights service 610 may generate computer-implemented graphical user interfaces 508 (see FIGS. 8A-8K, for example). Insights service 610 may operate one or more software applications on a server device exemplified by computing device 200, or on a server cluster exemplified by server cluster 304.

### 4. EXAMPLE DISPLAY ADVERTISING

As noted above, online advertising may include email advertising, search engine advertising, social media advertising, affiliate advertising, and/or mobile advertising. Each of these types of advertising may be considered to be a channel through which the advertiser attempts to reach its audience. For purpose of example, the embodiments herein will focus on display advertising. Nonetheless, these embodiments may be used with other advertising channels.

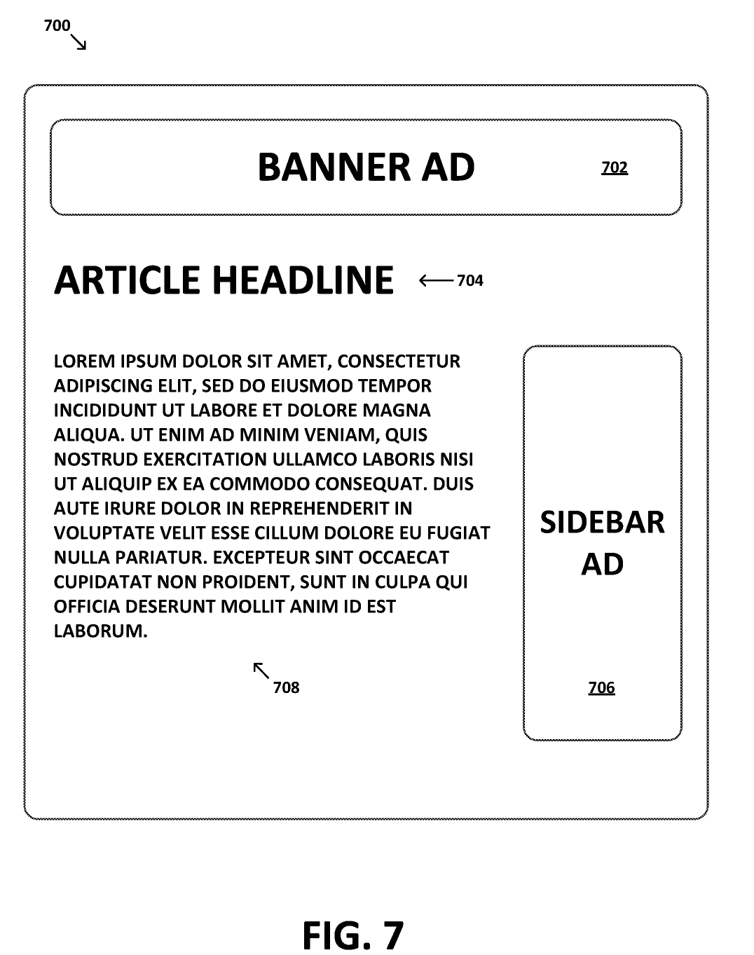

Display advertising is primarily focused on ads that are displayed on web sites. Such ads may include text, images, overlays, interstitials, animations, audio, and video. An example of display advertising is shown in FIG. 7.

In this figure, a web page 700 is shown. However, the contents of web page 700 could be displayed on other media, such as within an application. Web page 700 includes banner ad 702, article headline 704, sidebar ad 706, and article text 708.

Article headline 704 and article text 706 may be provided by the operator or author of web page 700. The web page may be an organization's webpage, a personal web page, a social networking web page, a blog, and so on. Article headline 704 and article text 706 may contain information related to the operator or author.

Banner ad 702 and sidebar ad 706 may be ads selected by an online advertising service for display on web page 700. For instance, web page 700 may include an extent of JavaScript code for each of banner ad 702 and sidebar ad 706, where the code includes a link to the online advertising service. When web page 700 is loaded by a client device, the code instructs the client device to execute a remote operation defined by the link, and the remote operation may trigger the selection of an ad.

As an example, JavaScript code that can be embedded in a web page is shown below. The lines of this piece of code are numbered for purpose of convenience.

1 <script type=“text/javascript”>
2 ad_client = “pub-6044026340890176”;
3 ad_slot = “3105157606”;
4 ad_width = 468;
5 ad_height = 60;
6 src=“http://www.example.com/pagead/show_ads.js”>
7 </script>

Lines 1 and 7 define a block indicating that the content therein is JavaScript. Lines 2-5 define the type of ad to be displayed. Line 2 specifies the publisher of the ad (e.g., the operator of the web site). Line 3 specifies a slot, or context, for the ad. Each web page for a particular publisher may have a different slot in order to allow different types of ads to be displayed on the same web site. Lines 4 and 5 specify the width and height, respectively, of the ad to be displayed. Line 6 specifies a URL of an online advertising service, the URL containing further code that, when accessed, selects an ad in accordance with the parameters specified in lines 2-5.

Thus, when web page 700 is loaded into a client device, the client device may display a representation of web page 700 in accordance with FIG. 7. This may involve the client device retrieving relevant and/or context-sensitive ad copy to place in banner ad 702 and sidebar ad 706. Nonetheless, other types of ads and ad placements are possible, and FIG. 7 is merely for purpose of example.

### 5. EXAMPLE ADVERTISING METRICS

It is desirable to be able to determine and/or quantify the success of an advertising campaign. This success, however, can be measured in different ways for different campaigns. For instance, in some campaigns, the number of impressions might be the most relevant metric. In other campaigns, conversions might be more important than impressions. For many campaigns, the cost of the campaign, perhaps in units of currency per time period (e.g., dollars per day) is an important factor.

Given this disparity, it is beneficial for the graphical user interfaces disclosed herein to be able to support a wide variety of metrics with which advertising can be evaluated. This section contains descriptions of some such metrics. Nonetheless, other metrics may be used with any of the embodiments herein.

Most of the metrics discussed below can be provided (1) per a particular keyword, (2) per a group of two or more keywords, (3) per a particular advertising campaign, (4) per a group of two or more advertising campaigns, (5) per a particular piece of ad copy, (6) per multiple pieces of ad copy, or (7) per any one or more of these metrics. For purpose of discussion, an “item of interest” can refer to any of the categories above, or other categories related to display advertising. Each metric may be determined over a particular period of time (e.g., an hour, day, week, month, custom period of time, etc.).

As an example, an item of interest may be all ads that are associated with a particular set of keywords and displayed as part of a particular advertising campaign over the course of a particular week. As another example, an item of interest may be a single ad (i.e., a particular piece of ad copy) displayed across multiple advertising campaigns during the previous month. Additional examples exist.

Further, these metrics can be divided into several logical categories including: performance, cost, conversions, revenue, cross-device conversions, cross-device revenue, and video. Other categories are possible.

A. Performance

Performance relates to how well an item of interest is being exposed to users.

| Metric | Description |
|---|---|
| Impressions | Related to the number of times that an item of interest was |
| | request by and transmitted to a device. For instance, |
| | impressions may represent the number of ads provided for a |
| | particular keyword or keywords, and/or the number of |
| | displayed ads for a particular campaign or campaigns. |
| Clicks | Related to the number of times that an item of interest was |
| | clicked on, selected, or otherwise accessed. Clicks are |
| | expected to be no more than the number of impressions |
| | for the same item of interest over the same time period. |
| Click- | CTR may represent a ratio of clicks to impressions for |
| Through | an item of interest. For instance, if an ad had 1000 |
| Rate (CTR) | impressions and 7 clicks in a time period, the CTR is |
| | 7/1000 or 0.7%. |

B. Cost

Cost is related to expenses of advertising accrued by the advertiser from displayed ads.

| Metric | Description |
|---|---|
| Media | Related to the total cost to the advertiser of all activities |
| Cost | (e.g., impressions, clicks, etc.) on an item of interest. |
| CPM | Related to the cost to the advertiser for every 1000 |
| | impressions of an item of interest. |
| Cost Per | Related to the average cost to the advertiser for each type of |
| Action | conversion (e.g., impressions, clicks, and/or other activities) |
| (CPA) | for an item of interest. |
| Agency | Related to any fees charged by a marketing or advertising |
| Fees | agency to the advertiser. |
| Ad Serving | Related to the fees charged by an online advertising service |
| Fees | to the advertiser for serving ads. |
| Total Cost | Related to the sum of all costs and fees paid by the |
| | advertiser. |

C. Conversions

As noted above, conversions relate to the number of times that a user has engaged in an activity that the advertiser deems to be valuable. Conversions may include impressions, clicks-throughs, viewing video or other multimedia content, downloads, phone calls, purchases, and so on.

| Metric | Description |
|---|---|
| Click-Through | Related to the number of times that users have performed |
| Conversions | any of one or more pre-defined activities after clicking |
| | through an item of interest. |
| View-Through | Related to the number of times that users have performed |
| Conversions | any of one or more pre-defined activities after viewing |
| | an item of interest, but not clicking through it. For |
| | example, viewing a video advertisement for a product |
| | then purchasing that product may be counted as a view- |
| | through conversion. |
| Total | Related to the sum of click-through conversions, view- |
| Conversions | through conversions, and any other type of supported |
| | conversions. |
| Total Adjusted | Related to a weighted version of total conversions. |
| Conversions | Different types of conversions might have different |
| | attribution rates. For instance, if view-through |
| | conversions are only given 10% weight but click-through |
| | conversions are given 100% weight, the total adjusted |
| | conversions for 10 view-through conversions and 3 click- |
| | through conversions is 4. Attribution rates may vary by |
| | advertiser and/or campaign. |
| Conversion | Related to an average number of conversions per click on |
| Rate | an item of interest. This value may be a percentage. For |
| | instance, if there were 1000 clicks during a time period, |
| | 30 of which led to conversions, then the conversion rate |
| | for this time period would be 3%. This value may alter- |
| | natively be calculated using impressions. For example, |
| | if there were 1000 impressions during a time period, 15 |
| | of which led to conversions, then the conversion rate |
| | for this time period would be 1.5%. |

D. Revenue

Revenue is related to the income to the advertiser that can be attributed to advertising.

| Metric | Description |
|---|---|
| Click-Through | Related to the revenue to the advertiser due to users |
| Revenue | clicking through an item of interest. |
| View-Through | Related to the total revenue to the advertiser, due to users |
| Revenue | viewing an item of interest, but not clicking through it. |
| Total Revenue | Related to the sum of click-through revenue, view- |
| | through revenue, and any other type of revenue. |
| Return on | Related to revenue from conversions attributable to |
| Advertising | advertising for an item of interest divided by the amount |
| Spend (ROAS) | the advertiser spent on that advertising. |
| Average Order | Related to the total revenue to the advertiser for an |
| Value (AOV) | item of interest divided by the number of conversions |
| | that resulted in the revenue. |
| Revenue Per | Related to the total revenue to the advertiser for an |
| Click (RPC) | item of interest divided by the number of user clicks |
| | on the item of interest that led to this revenue. |

E. Cross-Device Conversions

A cross-device conversion occurs when a user initially interacts with an item of interest on one device, and that activity leads to a conversion at a later point in time when the user is using a different device, is in a store, or purchases a product or service over the phone. For example, a user may click through an ad from his or her tablet device. The ad may load a landing web page on the tablet device, and this web page may include a phone number at which orders can be placed. The user may then call this phone number and place an order for a product or service related to the ad. Such a transaction is an example of a cross-device conversion.

| Metric | Description |
|---|---|
| Cross Device | Related to the number of times that an item of interest |
| Click-Through | was clicked through by a user on a particular device, |
| Conversions | and then that user was later involved in a conversion |
| | associated with the item of interest while not using |
| | the particular device. |
| Cross-Device | Related to the number of times that an item of interest |
| View-Through | was viewed by a user on a particular device, and then |
| Conversions | that user was later involved in a conversion associated |
| | with the item of interest while not using the particular |
| | device. |
| Cross | Related to the number of cross-device conversions |
| Conversion | (including cross device click-through and cross-device |
| Rate | view-through conversions) for an item of interest |
| | divided by the total number of impressions for the |
| | item of interest. |

F. Cross-Device Revenue

Cross-device revenue is related to the income to the advertiser that can be attributed to cross-device conversions.

| Metric | Description |
|---|---|
| Cross- | Related to the revenue to the advertiser resulting from an item |
| Device | of interest being clicked through by a user on a particular |
| Click- | device, and then that user later being involved in a revenue- |
| Through | generating conversion associated with the item of interest |
| Revenue | while not using the particular device. |
| Cross- | Related to the revenue to the advertiser resulting from an item |
| Device | of interest being viewed by a user on a particular device, and |
| View- | then that user later being involved in a revenue-generating |
| Through | conversion associated with the item of interest while not using |
| Revenue | the particular device. |
| Total | Related to the amount of revenue to the advertiser resulting |
| Cross | from cross-device conversions (including cross device click- |
| Revenue | through and cross-device view-through conversions) for an |
| | item of interest. |

G. Video

Video information includes any activity related to video-based advertising. These activities may involve views, view-throughs, associated revenue, and so on.

| Metric | Description |
|---|---|
| Video Plays | Related to the number of times that a user initiated playing |
| | of a video-based item of interest. |
| Video Q1 | Related to the number of times that a user initiated playing |
| Completions | of a video-based item of interest, and completed watching |
| | at least the first quarter of the video. |
| Video Q2 | Related to the number of times that a user initiated playing |
| Completions | of a video-based item of interest, and completed watching |
| | at least the first half of the video. |
| Video Q3 | Related to the number of times that a user initiated playing |
| Completions | of a video-based item of interest, and completed watching |
| | at least the first three-quarters of the video. |
| Video | Related to the number of times that a user initiated playing |
| Completions | of a video-based item of interest, and completed watching |
| | the whole video. |
| Video | Related to the number of video completions for an item of |
| Completion | interest divided by the number of video plays for that |
| Rate | item of interest. |
| Cost Per | Related to the cost to the advertiser for video plays |
| Completed | divided by the number of video completions. |
| Video | |
| (CPCV) | |

### 6. EXAMPLE GRAPHICAL USER INTERFACES

FIGS. 8A-8K depict screen captures of graphical user interfaces, in accordance with example embodiments. Each of these graphical user interfaces may be provided for display on a client device. The information provided therein may be derived, at least in part, from data stored in a database, such as database 600. Nonetheless, these graphical user interfaces are merely for purpose of illustration. The embodiments described herein may provide graphical user interfaces that format information differently, include more or less information, include different types of information, and relate to one another in different ways.

One of the difficulties that advertisers and advertising agencies encounter is that it is challenging to be able to measure the performance of online advertising campaigns at both a high level and low level. While these entities can track advertising cost and conversions, for example, on a weekly or monthly basis, it is hard to know how much spending on which campaigns, on what days, are actually resulting in conversions. Additionally, advertising performance might vary based on the type of device used to view an ad, as well as the online advertising service that provides the ad.

As described above, data can be collected for many of the metrics discussed in the previous section. But, an advertiser or advertising agency may be simultaneously managing hundreds or thousands (or even more) advertising campaigns. Thus, the amount of data may be overwhelming. As a consequence, technical tools are required to be able to filter and process this data so that it can be presented in a manageable fashion on one or more configurable graphical user interfaces. Doing so may provide insights into the efficacy of online advertising performance that would otherwise be unavailable.

As just one example, suppose that an advertiser is running a display-based advertising campaign with two different pieces of ad copy. With the embodiments herein, the advertiser would be able to determine which of these two ads results in higher conversions or a lower cost per conversion. Further, if one of the ads exhibits a drop in conversions from week to week, the embodiments herein may be able to help the advertiser determine on which day or days the drop occurred, and why the drop occurs at that time. For instance, the advertiser may be able to determine that the drop is correlated with the ad's quality score also dropping. In response to making these observations, the advertiser may take measures to increase the ad's quality score so that the ad's conversions are likely to increase. In some cases, this may involve improving the quality of a landing page associated with the ad, increasing the bidding budget for the ad, or designing more relevant ad copy. The computerized embodiments herein may suggest one or more of these approaches based on the data collected for the ad.

In another example, an advertiser may be running a display-based advertising campaign for which certain keywords are performing well in terms of ROAS. But, with the embodiments herein, the advertiser will also be able to rapidly determine the impressions of ads related to these keywords. If the impressions is deemed to be low, then the advertiser would know that additional impressions can be achieved by, for instance, improving ad content or increasing the bid amount for the keywords.

Notably, the embodiments herein require computer implementation. By its very nature, online advertising is premised on the existence of computers and computer networks. Billions of people around the world, accessing the Internet or private networks in various ways, may be served ads. Tracking the performance of these ads, such as the associated number of impressions, clicks, and conversions, occurs on computers that are connected via networks.

Further, there are no non-computerized analogies for such activities. For instance, there is no way to accurately determine how many people have viewed an ad in a print newspaper, much less reliably determine whether a viewing of that ad resulted in a conversion. Thus, the solutions presented herein a specifically designed to solve technical problems related to online advertising.

Moreover, these solutions may take the form of graphical user interfaces that present information that is filtered and organized so that an advertiser or advertising agency can rapidly determine the status of a large number of online advertising campaigns. These graphical user interfaces automatically provide intuitive and insightful reports that would not be possible to obtain for traditional methods of advertising.

For instance, an advertiser can determine, by way of the graphical user interfaces described herein, the current allocation of advertising funds across multiple channels, brands and advertising campaigns. Given that these funds are typically limited, the advertiser may re-allocate the funds on a weekly, daily, or even hourly basis. For instance, the advertiser may move funds from high-performing campaigns to low-performing campaigns, or from one set of keywords to another set of keywords. In the past, the information to make such a decision was not available, or if it was, collating that information would take such a long time that the advertiser could not respond to optimization opportunities in real time.

As an example, on the morning of one particular day, an advertiser might notice that a critical advertising campaign is registering fewer impressions and revenue than it had on previous days. After some investigation, the advertiser may conclude that this is due to competitors outbidding the advertiser for certain keywords. In response, the advertiser can immediately increase its own bids for these keywords (e.g., by re-allocating funds from less important campaigns), and by afternoon of the same day, the advertiser may be able to confirm that the campaign is once again performing as expected. This sort of real time responsiveness would not be possible in traditional advertising.

Non-limiting examples of such graphical user interfaces are described below. Nonetheless, these examples are made for purpose of illustration, and other graphical user interfaces, and layouts of information therein, may be possible.

FIG. 8A depicts a display insights graphical user interface 800. Graphical user interface 800 includes chart 812 above table 816. Both chart 812 and table 816 provide insight into the performance of display advertising campaigns for a particular client or entity. In subsequent figures, variations of chart 812 and table 816 are depicted separately for purposes of simplicity. However, any combination of a chart and a table can be joined into a single graphical user interface, in the fashion depicted in FIG. 8A or differently. In some embodiments, the information displayed on chart 812 and table 816 may be related, e.g., such that use of a control on one of chart 812 or table 816 impacts the information displayed in both.

As an example, suppose that the chart and table are displaying information at the campaign level. If the advertiser operates a control (e.g., control 818) to display information in the table at the trend of week level, the chart may automatically update to plot the associated trend of week data. Further, if the advertiser operates a control to display information in the table at the ad size level, the chart may automatically update to plot the associated ad size data.

Graphical user interface 800 includes also a header section that provides an entity selector 802, campaign status selector 804, and date range selector 806. Chart 812 includes metric selector 808, metric selector 810, and chart granularity 814. In various embodiments other information may be displayed on or omitted from a chart of graphical user interface 800, and the displayed information can be arranged differently than depicted in FIG. 8A. For instance, in FIGS. 8B-8G, different example displays of such information are provided.

Table 816 includes a report type selector 818, a presets selector 820, a columns selector 822, advanced filters selector 824, table header row 826, table summary row 828, and table entry rows 830a, 830b, and 830c. In various embodiments other information may be displayed on or omitted from a table of graphical user interface 800, and the displayed information can be arranged differently than depicted in FIG. 8A. For instance, in FIGS. 8H-8K, different example displays of such information are provided.

Entity selector 802, campaign status selector 804, date range selector 806, metric selector 808, metric selector 810, chart granularity 814, report type selector 818, presets selector 820, columns selector 822, and advanced filters selector 824 may be referred to herein as “controls.” These controls allow the advertiser to modify what is being displayed on graphical user interface 800. For instance, by changing the selection of one or more of these controls, the advertiser's client device may request, and a server device (e.g., a device providing insight service 610) may retrieve, information from database 600 to fulfill the request.

In this manner, the advertiser remotely controls the server devices operating insight service 610 and database 600, while a server device operating insight service 610 remotely controls the advertiser's client device. As an example of the latter, the server device may transmit data and instructions to the client device that cause the client device to plot the data in chart 812 and to organize the data in table 816.

The following subsections provide non-limiting descriptions of the components of graphical user interface 800.

A. Entity

Entity selector 802 may be a drop down menu or another type of control that allows an advertiser to select a particular entity (e.g., a client, a business, etc.). Once selected, information relating to the display advertising performance of that particular entity may be displayed in chart 812 and table 816. In FIG. 8A, entity selector 802 depicts the entity “Client 1” as selected.

B. Brand Status

Brand status selector 804 may be a drop down menu or another type of control that allows an advertiser to select a particular brand status. Then, only information related to advertising campaigns with the selected brand status is displayed in chart 812 and table 816. Examples of brand statuses include active, paused, and incomplete. Other brand statuses may be possible.

Active brands are ones for which advertising spending is occurring and conversions can be measured. All brands described herein are active.

Paused brands, on the other hand, are ones for which advertising is not supposed to be occurring. Some products or services are seasonal, and their associated branded advertising campaigns are paused when these products or services are off-season. For instance, advertising for hot chocolate might be paused during summer months, and advertising for lawn services might be paused during winter months. This particular selector may be used so that the advertiser and/or advertising agency can verify that there is no advertising spending for paused brands.

Incomplete brands are ones for which advertising spending can be monitored, but advertising conversions either cannot be monitored or have not yet been set up to be monitored. Thus, the performance of these brands cannot fully be measured.

In addition or as an alternative to status at the brand level, status may be provided at the campaign level. Similar to brand status, campaign status can be active, paused, or incomplete.

C. Metrics

Metric selector 808 and metric selector 810 may be drop down menus or other types of controls that each allow an advertiser to select a metric related to display advertising. In the embodiment depicted in FIG. 8A, metric selector 808 controls the metric used for the left-hand y-axis of chart 812, and metric selector 810 controls the metric used for the right-hand y-axis of chart 812.

For instance, metric selector 808 depicts the metric impressions as selected, and impressions is the unit used for the left-hand y-axis of chart 812. Similarly, metric selector 810 depicts the metric CPM as selected, and CPM is the unit used for the right-hand y-axis of chart 812. Other possibilities exist.

In some embodiments, metric selector 808 and metric selector 810 may be configured so that the metric selected for one is not available for selection to the other. For instance, if impressions is the metric selected for metric selector 808, then impressions might not be available for selection by way of metric selector 810.

Each metric selector may display any metric discussed herein, including those described in the previous section. These may include any metric discussed in the subsections directed to performance, cost, conversions, revenue, cross-device conversions, cross-device revenue, video, and so on. Other metrics are possible.

FIG. 8B displays a drop down menu 808a showing a list of selectable metrics for metric selector 808. Clicks is shown as selected, while impressions, CTR, and media cost are available for selection. The scroll bar on the right side of drop down menu 808a can be slid downward to reveal further selectable metrics. A similar drop down menu may be implemented for metric selector 810.

FIGS. 8C, 8D, and 8E provide examples of different metrics being selected for metric selector 808. Particularly, in FIG. 8C chart 812 depicts clicks versus CPM. As might be suspected, there is a strong correlations between clicks and CPM in the displayed data, likely because an ad with a given cost is likely to attract a certain number of clicks.

In FIG. 8D, chart 812 depicts cross-device view-through conversions versus CPM. The correlation between these two metrics is less apparent, perhaps because there is a relatively small sample size for the cross-device view-through conversions.

FIG. 8E depicts video plays versus total conversions. The correlation between these two metrics is reasonably strong, as more video plays of an ad may encourage users to purchase, or otherwise engage with, the products or services offered therein.

D. Date Range

Date range selector 806 may allow an advertiser to specify a range of dates for which information is to be displayed on chart 812 and table 816. In FIGS. 8A-8F, this range of dates is Sep. 1, 2016 to Sep. 11, 2016, and is used to determine the x-axis of chart 812.

To select a date range, an advertiser might, for instance, specify a starting date and an ending date. In some embodiments, a default date range, such as month-to-date range may be provided. Regardless, upon selection of a date range, display advertising performance data might only be displayed for time periods within the selected date range.

FIG. 8F depicts drop down menu 806a showing a list of selectable date ranges for date range selector 806. “This month” is shown as selected, while “yesterday,” “week to date,” “last week,” “last 7 days,” “last 14 days,” “last 30 days,” “last month,” “quarter to date,” “last quarter,” “year to date,” “last 12 months,” rolling 13 months,” and “custom” are available for selection. If the custom option is selected, the advertiser may specify a date range. As an example of one of the possible date ranges, FIG. 8G depicts cross-device view-through conversions versus CPM with “last 12 months” chosen with date range selector 806.

E. Chart

Chart 812 may display a chart or graph comparing the metric selected using metric selector 808 with the metric selected using metric selector 810. One possible implementation is shown in FIG. 8A where chart 812 is a double y-axis graph. The x-axis of this graph represents the days of the date range selected by date range selector 806. The left y-axis represents impressions, as determined by metric selector 808, and the right y-axis represents CPM, as determined by metric selector 810.

In FIG. 8A, impressions is plotted with a solid line and CPM is plotted with a dash-dot line. Notably, the ranges of one or both the left and right y-axes are normalized so that these lines appear in approximately the same location of chart 812. Such normalization may consider the maximum values of the each data set, and scale the y-axes such that these maximum values appear at approximately the same vertical location on chart 812. Overall this chart indicates that there is a strong correlation between the number of impressions of ads and the cost per thousand ad impressions for the specified time period. Clicking on, hovering over, or otherwise selecting a date on the x-axis of chart 814 may result in a text box popping up displaying the values of the selected metrics for this date.

F. Chart Granularity

Chart granularity 814 may allow an advertiser to select the amount of time represented by each point on the x-axis of chart 812. For instance, FIG. 8A shows each such point representing one day. However, a granularity of a week or month may be selected instead.

When week is selected, each point on the x-axis may represent a week from the first week of the current month until the current week (or until the week before the current week). Alternatively, a particular number of weeks may be displayed, such as the most recent 4 weeks. Weeks may be defined to start on Sunday, Monday, or any other day of the week. Further, weeks may be defined to have more or fewer than seven days.

When month is selected, each point on the x-axis may represent a month from the first month of the current year until the current month (or until the month before the current month). Alternatively, a particular number of months may be displayed, such as the most recent 12 months. Any of these ranges may be further limited by the availability of data for the requested time period.

G. Table

Table 816 displays a number of columns and rows. Each column may represent either a way in which display advertising can be categorized or identified, or may represent advertising performance data. As shown in FIG. 8A, the leftmost column depicts date ranges, while the remaining columns each display values related to a metric. Any metric discussed in the previous section may be displayed in a column.

Each row may represent one or more advertising campaigns, ad copy, ad copy sizes, ad placements, timeframes, or other organizations of advertising information. These representations may be chosen by way of report type selector 818. It may be possible, by way of graphical user interface 800, to sort the rows in ascending or descending order based on the information displayed in one or more of the columns.

Further, Table 816 may allow for custom reporting. In particular, custom groupings of advertising information may be created. For instance, a custom grouping may involve grouping all campaign data for campaigns with the term “life insurance” within the campaign name, or within a particular position in the campaign name.

H. Table Rows

Table header row 826 may represent column headers for each column displayed in table 816.

Table summary row 828 may represent a total, weighted total, or weighted average of the values represented in the following rows of the table. For instance, in FIG. 8A, the entry of table summary row 828 for the impressions (“Impr.”) column includes a sum of ad impressions occurring in the weeks starting on Aug. 28, 2016, Sep. 4, 2016, and Sep. 11, 2016. Similarly, the entry of table summary row 828 for the CTR column is the CTR for ads over the same time frame. Note that the rows are sorted in descending order of impressions rather than by date.

Table entry rows 830a, 830b, and 830c may represent entries for each column in the table. For instance, in the summary column, table entry row 830a specifies that this row relates to metrics from the week of Sep. 4, 2016. Similarly, table entry row 830b specifies that this row relates to metrics from the week of Aug. 28, 2016, and table entry row 830c specifies that this row relates to metrics from the week of Sep. 11, 2016.

I. Report Type

Report type selector 818 may be a drop down menu or another type of control that allows an advertiser to select a particular predefined report for display in table 816. The selected report type may determine, to some extent, the columns displayed in table 816. A number of report types may be available, some of which are described below. FIG. 8H displays a drop down menu 818a for selecting a report type.

For instance, a campaign report type may break out metrics per advertising campaign and site. The site may be a reporting source, such as one or more server devices associated with advertising spending 606 and/or advertising conversions 608. Thus, a site may refer to an online advertising service provider or an organization that tracks conversions from online advertising. An example of the campaign report type is shown in FIG. 8I.

A creative report type may include columns that identify specific ad copy, as well as where this ad copy is being used (i.e., the ad placement). The data appearing in these columns may be strings defined by the advertiser or online advertising agency. The strings may specify on what sites the ad copy is being placed, strategic partners associated with the ad copy, the scope of ad placement (e.g., nationwide, statewide, local, etc.), or any other information.

A placement report type may include columns that identify where ad copy is being used (i.e., the ad placement) and the advertising campaign with which the ad copy is associated. The data appearing in these columns may be strings defined by the advertiser or online advertising agency.

A trend of week report type may include a column for each week of a given time period, and all display metrics may relate to this week. FIGS. 8A and 8K provide examples of trend of week report types. For instance, in FIG. 8A, ads displayed in the week of Sep. 4, 2016 had 372,977 impressions.

A size report size may include a column for the size of each ad copy in terms of its pixel-by-pixel dimensions, and all display metrics may relate to ad copy of this size. FIG. 8J provides an example of a size report type. For instance, ad copy of size 160×600 have had 367,859 impressions. In this report, 0x0 and 1x1 sizes may refer to web beacons (also known as “web bugs”), which are tags used to track user activity across sites in an invisible or substantially invisible fashion.

J. Presets

Presets selector 820 may be a drop down menu or another type of control that allows an advertiser to select a particular set of columns for display in table 816. Presets selector may include at least some of the following selections.

An all columns preset, when selected, causes table 816 to display a column for each metric discussed in the previous section. A cross-device preset, when selected, causes table 816 to display a column for each cross-device metric discussed in the previous section, as well as several additional metrics including impressions, clicks, CTR, and CPM. A single-device preset, when selected, causes table 816 to display a column for each metric discussed in the previous section that is not related to cross-device activity. A standard preset, when selected, causes table 816 to display a column for each metric related to performance, revenue, and cost. FIGS. 8A, 8H, 8I, and 8J provide examples of the standard preset. A video preset, when selected, causes table 816 to display a column for each metric related to video advertisements, as shown in FIG. 8K.

K. Columns Selector

Columns selector 822 may be a drop down menu or another type of control that allows an advertiser to select individual columns to display in table 816. Some or all of the columns that appear in this table each may be associated with a metric described in the previous section (e.g., impressions, CPM, and so on). When in the form of a drop down menu, the control may display a scrollable list of columns with a checkbox next to each. Columns with a checked checkbox may be displayed, and columns without a checked checkbox might not be displayed. The advertiser may be able to check and uncheck these boxes, thus adding columns to and removing columns from table 816.

L. Advanced Filters

Advanced filters selector 824 may be a drop down menu or another type of selector that allows an advertiser to either select a pre-determined filter term, or to enter a custom filter term. Pre-determined filter terms may include the names of any of the columns discussed herein, for example. Once a filter term is selected and applied, only rows including that filter term might be displayed. Filter terms may include numerical values and numerical operators that can be applied to any numerical data visible in table 816.

### 7. EXAMPLE OPERATIONS

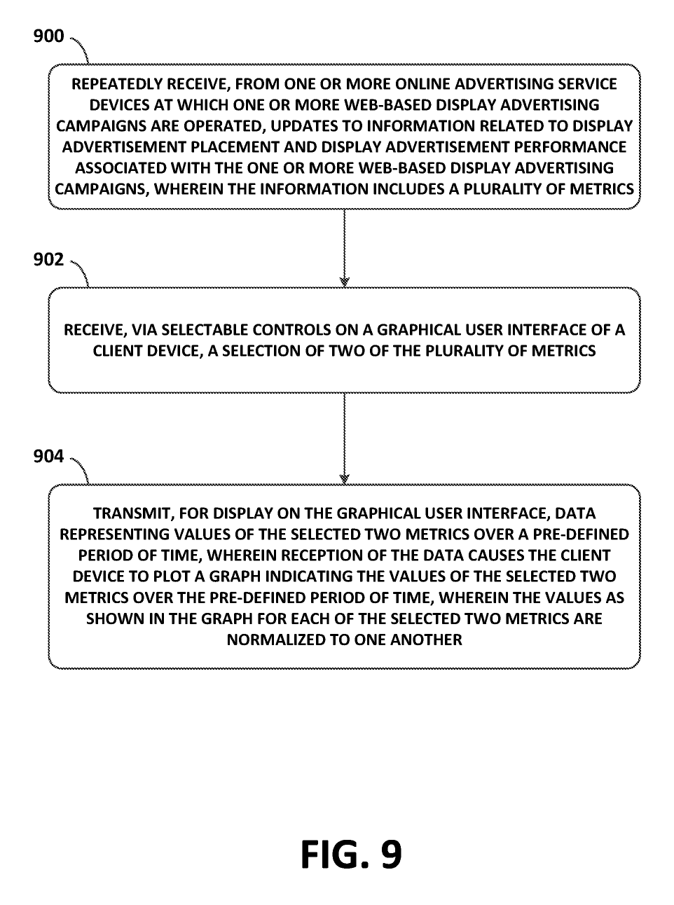

FIG. 9 is a flowchart illustrating an example embodiment. The process illustrated by FIG. 9 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

Block 900 may involve repeatedly receiving, from one or more online advertising service devices at which one or more web-based display advertising campaigns are operated, updates to information related to display advertisement placement and display advertisement performance associated with the one or more web-based display advertising campaigns. The information may include a plurality of metrics.

Block 902 may involve receiving, via selectable controls on a graphical user interface of a client device, a selection of two of the plurality of metrics.

Block 904 may involve transmitting, for display on the graphical user interface, data representing values of the selected two metrics over a pre-defined period of time. Reception of the data may cause the client device to plot a graph indicating the values of the selected two metrics over the pre-defined period of time. The values as shown in the graph for each of the selected two metrics are normalized to one another.

Some embodiments may further involve: (i) receiving, via the selectable controls on the graphical user interface, a selection of two report options, one defining a type of report, the other defining types of data to be reported, (ii) possibly based on the selected two report options, determining a subset of the information related to the display advertisement placement and display advertisement performance, and (iii) transmitting, by the computing device for display on the graphical user interface, data representing values of the subset of the information over the pre-defined period of time. Reception of the data may cause the client device to display a table indicating the values of the subset of the information over the pre-defined period of time. The columns and rows of the table may be defined by the type of report and the types of data to be reported.

In some embodiments, the graphical user interface includes a column selection control configured to change the columns of the table as displayed to user-defined selections. Alternatively or additionally, the graphical user interface may include a filter selection control that is configured to define a filter. The defined filter may be specified by an operation applied to a particular metric of the plurality of metrics. The filter selection control, when applied, may cause the table to be filtered based on the defined filter.

In some embodiments, the types of data define metrics columns that appear in the table. Each metrics column may display values associated with one of the plurality of metrics. In one example, the type of report is a campaign report that defines columns for advertising campaigns and sites. The defined columns may appear in the table. Entries in the advertising campaigns column may be strings defined by an advertiser or an online advertising agency, and entries in the sites column may be associated with online advertising service providers or organizations that track conversions from online advertising. Entries in the metrics columns may be displayed per entries in the advertising campaigns and sites columns.

In another example, the type of report may be a creative report that defines columns for ad copy and placements of the ad copy. The defined columns may appear in the table. Entries in the ad copy and placements columns may be strings defined by an advertiser or an online advertising agency. Entries in the metrics columns may be displayed per entries in the ad copy and placements columns.

In another example, the type of report may be a placement report that defines columns for placements of ad copy and advertising campaigns associated with the ad copy. The defined columns may appear in the table. Entries in the placements and advertising campaign columns may be strings defined by an advertiser or an online advertising agency. Entries in the metrics columns may be displayed per entries in the placements and advertising campaigns columns.

In another example, the type of report may be a trend of week report that defines a column for weeks. The defined column may appear in the table. Entries in the metrics columns may be displayed per entries in the weeks column.

In another example, the type of report may be a size report that defines a column for ad copy size. Entries in the ad copy size column may be associated with sizes of ad copy. The defined column may appear in the table. Entries in the metrics columns may be displayed per entries in the ad copy size column.

In some embodiments, the selected two report options are received via selectable report menu controls on the graphical user interface. Alternatively, the selected two report options may be automatically selected, by a computing device, based on the selected two metrics.

In some embodiments, the pre-defined period of time is a month-to-date period of time with entries for each day in the pre-defined period of time. The graph may represent the pre-defined period of time on an x-axis and represent each of the values of the selected two metrics on respective y-axes.

In some embodiments, the selected two metrics each relate to different measurements of: performance of online advertising, cost of the online advertising, conversions of the online advertising, cross-device conversions of the online advertising, cross-device revenue of the online advertising, or video ads of the online advertising.

In some embodiments, the updates to the information are repeatedly received from two or more online advertising service devices that are operated by different online advertising service providers. Values of the selected two metrics may include aggregations of the information received from all of the two or more online advertising service devices.

The embodiments of FIG. 9 may be simplified by the removal of any one or more of the features shown therein. Further, these embodiments may be combined with features, aspects, and/or implementations of any of the previous figures or otherwise described herein.

### 8. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flowcharts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrently or in reverse order, depending on the functionality involved. Further, more or fewer blocks and/or functions can be used with any of the ladder diagrams, scenarios, and flowcharts discussed herein, and these ladder diagrams, scenarios, and flowcharts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
repeatedly receiving, by a computing device from one or more online advertising service devices at which one or more web-based display advertising campaigns are operated, updates to information related to display advertisement placement and display advertisement performance associated with the one or more web-based display advertising campaigns, wherein the information includes a plurality of metrics;
receiving, by the computing device via selectable controls on a graphical user interface of a client device, a selection of two of the plurality of metrics; and
transmitting, by the computing device for display on the graphical user interface, data representing values of the selected two metrics over a pre-defined period of time, wherein reception of the data causes the client device to plot a graph indicating the values of the selected two metrics over the pre-defined period of time, wherein the values as shown in the graph for each of the selected two metrics are normalized to one another.

2. The method of claim 1, further comprising:
receiving, via the selectable controls on the graphical user interface, a selection of two report options, one defining a type of report, the other defining types of data to be reported;
based on the selected two report options, determining a subset of the information related to the display advertisement placement and display advertisement performance; and
transmitting, by the computing device for display on the graphical user interface, data representing values of the subset of the information over the pre-defined period of time, wherein reception of the data causes the client device to display a table indicating the values of the subset of the information over the pre-defined period of time, wherein the columns and rows of the table are defined by the type of report and the types of data to be reported.

3. The method of claim 2, wherein the graphical user interface includes a column selection control configured to change the columns of the table as displayed to user-defined selections.

4. The method claim 2, wherein the graphical user interface includes a filter selection control that is configured to define a filter, wherein the defined filter is specified by an operation applied to a particular metric of the plurality of metrics.

5. The method of claim 4, wherein the filter selection control, when applied, causes the table to be filtered based on the defined filter.

6. The method of claim 2, wherein the types of data define metrics columns that appear in the table, wherein each metrics column displays values associated with one of the plurality of metrics.

7. The method of claim 6, wherein the type of report is a campaign report that defines columns for advertising campaigns and sites, wherein the defined columns appear in the table, wherein entries in the advertising campaigns column are strings defined by an advertiser or an online advertising agency, wherein entries in the sites column are associated with online advertising service providers or organizations that track conversions from online advertising, and wherein entries in the metrics columns are displayed per entries in the advertising campaigns and sites columns.

8. The method of claim 6, wherein the type of report is a creative report that defines columns for ad copy and placements of the ad copy, wherein the defined columns appear in the table, wherein entries in the ad copy and placements columns are strings defined by an advertiser or an online advertising agency, and wherein entries in the metrics columns are displayed per entries in the ad copy and placements columns.

9. The method of claim 6, wherein the type of report is a placement report that defines columns for placements of ad copy and advertising campaigns associated with the ad copy, wherein the defined columns appear in the table, wherein entries in the placements and advertising campaign columns are strings defined by an advertiser or an online advertising agency, and wherein entries in the metrics columns are displayed per entries in the placements and advertising campaigns columns.

10. The method of claim 6, wherein the type of report is a trend of week report that defines a column for weeks, wherein the defined column appears in the table, and wherein entries in the metrics columns are displayed per entries in the weeks column.

11. The method of claim 6, wherein the type of report is a size report that defines a column for ad copy size, wherein entries in the ad copy size column are associated with sizes of ad copy, wherein the defined column appears in the table, and wherein entries in the metrics columns are displayed per entries in the ad copy size column.

12. The method of claim 2, wherein the selected two report options are received via selectable report menu controls on the graphical user interface.

13. The method of claim 2, wherein the selected two report options are automatically selected, by the computing device, based on the selected two metrics.

14. The method of claim 1, wherein the pre-defined period of time is a month-to-date period of time with entries for each day in the pre-defined period of time.

15. The method of claim 1, wherein the graph represents the pre-defined period of time on an x-axis and represents each of the values of the selected two metrics on respective y-axes.

16. The method of claim 1, wherein the selected two metrics each relate to different measurements of: performance of online advertising, cost of the online advertising, conversions of the online advertising, cross-device conversions of the online advertising, cross-device revenue of the online advertising, or video ads of the online advertising.

17. The method of claim 1, wherein the updates to the information are repeatedly received from two or more online advertising service devices that are operated by different online advertising service providers.

18. The method of claim 17, wherein the values of the selected two metrics include aggregations of the information received from all of the two or more online advertising service devices.

19. An article of manufacture including a non-transitory computer-readable medium, having stored thereon program instructions that, upon execution by a computing device, cause the computing device to perform operations comprising:
repeatedly receiving, from one or more online advertising service devices at which one or more web-based display advertising campaigns are operated, updates to information related to display advertisement placement and display advertisement performance associated with the one or more web-based display advertising campaigns, wherein the information includes a plurality of metrics;
receiving, via selectable controls on a graphical user interface of a client device, a selection of two of the plurality of metrics; and
transmitting, for display on the graphical user interface, data representing values of the selected two metrics over a pre-defined period of time, wherein reception of the data causes the client device to plot a graph indicating the values of the selected two metrics over the pre-defined period of time, wherein the values as shown in the graph for each of the selected two metrics are normalized to one another.

20. A computing device comprising:
a processor;
memory; and
program instructions, stored in the memory, that upon execution by the at least one processor cause the computing device to perform operations comprising:
repeatedly receiving, from one or more online advertising service devices at which one or more web-based display advertising campaigns are operated, updates to information related to display advertisement placement and display advertisement performance associated with the one or more web-based display advertising campaigns, wherein the information includes a plurality of metrics;
receiving, via selectable controls on a graphical user interface of a client device, a selection of two of the plurality of metrics; and
transmitting, for display on the graphical user interface, data representing values of the selected two metrics over a pre-defined period of time, wherein reception of the data causes the client device to plot a graph indicating the values of the selected two metrics over the pre-defined period of time, wherein the values as shown in the graph for each of the selected two metrics are normalized to one another.
